(19) United States
(12) Patent Application Publication
(10) Pub. No.: US 2014/0172461 A1
(43) Pub. Date: Jun. 19, 2014

(54) SYSTEMS AND METHODS FOR WELLNESS PROGRAM ADMINISTRATION AND EVALUATION

(71) Applicant: Kevin Rogers, Louisville, KY (US)

(72) Inventor: Kevin Rogers, Louisville, KY (US)

(73) Assignee: Wellbeingz, Sarl, Gland (CH)

(21) Appl. No.: 14/148,285

(22) Filed: Jan. 6, 2014

Related U.S. Application Data
(63) Continuation-in-part of application No. 13/179,469, filed on Jul. 8, 2011, now abandoned.
(60) Provisional application No. 61/362,622, filed on Jul. 8, 2010.

(51) Int. Cl. G06F 19/00; G06Q 50/24

(52) U.S. Cl. CPC G06F 19/322; G06Q 50/24
USPC 705/3

(57) ABSTRACT

A computer-readable medium comprising computer-readable instructions for administering a wellness program, wherein execution of the computer-readable instructions causes one or more processors to carry out steps. Data corresponding to physical and psychological characteristics of at least one patient is received. One or more risk factors are determined corresponding to one or more conditions based, at least in part, on the physical and psychological characteristics of the at least one patient. One or more wellness prescriptions are determined based, at least in part, on the one or more risk factors and the physical and psychological characteristics of the at least one patient.

### CROSS-REFERENCE TO RELATED APPLICATIONS

The present application is a continuation-in-part of U.S. patent application Ser. No. 13/179,469, filed on Jul. 8, 2011, which claims priority from U.S. Provisional Application Ser. No. 61/362,622, entitled APPARATUS AND METHODS FOR MEDICAL DIAGNOSIS AND TREATMENT, filed on Jul. 8, 2010, specifications of which are herein incorporated by reference for completeness of disclosure.

### BACKGROUND OF THE INVENTION

1. Field of the Invention

Embodiments of the systems and methods for wellness program administration and evaluation described herein pertain to the field of computer systems. More particularly, but not by way of limitation, one or more embodiments of the systems and methods for wellness program administration and evaluation enable systems and methods for wellness program administration and evaluation.

2. Description of the Related Art

Healthcare costs are the largest long-term fiscal crisis facing the nation as costs are expected to rise at 8% to 12% per year for the foreseeable future. While ambitious plans are being made to find a way to provide each citizen with healthcare coverage, a key factor to the affordability of such a notion is prevention.

Unhealthy eating and activity habits by Americans account for the lion's share of the cause of chronic diseases in US and the healthcare costs that are incurred when someone is stricken with heart disease, diabetes, cancer, etc. According to the CDC, sixty-seven percent of adult Americans are overweight or obese. Individual efforts by citizens to adopt a healthy lifestyle have failed despite the wealth of information, diet programs and exercise equipment innovations. In addition, a large percentage of unhealthy citizens also suffer from chronic absenteeism and substantial productivity problems.

However, these problems are largely unaddressed on either an individual scale or systematically. Furthermore, wellness professionals typically do not emphasize wellness in a manner that effectively addresses these issues. In sum, no system successfully improves efficiency from the standpoint of a systematic wellness program, or provides accurate information regarding the effectiveness and cost of wellness programs.

To overcome the problems and limitations described above there is a need for systems and methods for wellness program administration and evaluation that address the real causes of unhealthy human behavior that stem from the acquisition of unhealthy habits and addictions to certain types of foods and substances that are buried in the subconscious and that cannot be dealt with and eradicated by anything less than a total mind/body approach where the “psychology of wellness” exposing the cross-correlation of these mind/body issues are understood, assessed and proper interventions to eradicate are provided.

### BRIEF SUMMARY OF THE INVENTION

One or more embodiments of systems and methods for wellness program administration and evaluation are directed to a computer-readable medium including computer-readable instructions for administering a wellness program.

Execution of the computer-readable instructions causes one or more processors to receive data corresponding to physical and psychological characteristics of at least one patient. The data corresponding to physical and psychological characteristics of a patient may include height and weight information. The data corresponding to physical and psychological characteristics of a patient may include biometric information. The data corresponding to physical and psychological characteristics of a patient may include information obtained from a blood test. The data corresponding to physical and psychological characteristics of a patient may include information obtained from a health evaluation.

Execution of the computer-readable instructions further causes one or more processors to determine one or more risk factors corresponding to one or more conditions based, at least in part, on the physical and psychological characteristics of the at least one patient. The one or more risk factors may include a high BMI. The one or more risk factors may include a high blood pressure. The one or more risk factors may include a behavior of the at least one patient. The one or more risk factors may include a blood chemistry level of the at least one patient. In one or more embodiments, determining the one or more risk factors includes applying at least one rule stored in rules database.

Execution of the computer-readable instructions causes one or more processors to determine one or more wellness prescriptions based, at least in part, on the one or more risk factors and the physical and psychological characteristics of the at least one patient.

In one or more embodiments, execution of the computer-readable instructions causes one or more processors to receive additional data corresponding to updated physical and psychological characteristics of the at least one patient.

In one or more embodiments, execution of the computer-readable instructions causes one or more processors to determine one or more updated risk factors corresponding to the one or more conditions based, at least in part, on the physical and psychological characteristics of the at least one patient.

In one or more embodiments, execution of the computer-readable instructions causes one or more processors to determine one or more updated prescriptions based, at least in part, on the one or more updated risk factors and the physical and psychological characteristics of the at least one patient.

In one or more embodiments, the computer-readable instructions further include maintaining at least one patient profile associated with the at least one patient.

In one or more embodiments, the computer-readable instructions further include determining at least one recommended treatment regime associated with one or more health professional. The computer-readable instructions may further include monitoring a progress of the at least one patient under the at least one treatment regime.

In one or more embodiments, the at least one patient is a member of an association. The association may be an insurance organization. The association may be a government organization. The association may be at least one employer. In one or more embodiments, the computer-readable instructions further include the step of receiving patient data for the at least one patient from the organization.

In one or more embodiments, the computer-readable instructions for administering a wellness program further include determining an expected cost associated with the one or more risk factors, determining an expected cost associated with the prescription, determining a reduced risk factor based, at least in part, the one or more risk factors, the prescription, the physical and psychological characteristics of the patient, determining an expected cost associated with the reduced risk factor, determining an expected savings based, at least in part, on the expected cost associated with the risk factor and the expected cost associated with the reduced risk factor, determining an expected return on investment based, at least in part, on the expected savings and the expected cost associated with the prescription, and providing the expected return on investment.

Various aspects of the novel systems, apparatus and methods are described more fully hereinafter with reference to the accompanying drawings. The developments described in the disclosure may, however, be embodied in many different forms and should not be construed as limited to any specific structure or function presented throughout this disclosure. Rather, these aspects are provided so that this disclosure will be thorough and complete, and will fully convey the scope of the developments to those skilled in the art. Based on the teachings herein one skilled in the art should appreciate that that the scope of the disclosure is intended to cover any aspect of the novel systems, apparatus, and methods disclosed herein, whether implemented independently of or combined with any other aspect of the embodiments described herein. For example, an apparatus may be implemented or a method may be practiced using any number of the aspects set forth herein. In addition, the scope of the development is intended to cover such an apparatus or method which is practiced using other structure, functionality, or structure and functionality in addition to or other than the various aspects of the development set forth herein. It should be understood that any aspect disclosed herein may be embodied by one or more elements of a claim.

### BRIEF DESCRIPTION OF THE DRAWINGS

The above and other aspects, features and advantages of the systems and methods for wellness program administration and evaluation described herein will be more apparent from the following more particular description thereof, presented in conjunction with the following drawings wherein:

FIG. 1 is a functional block diagram of a general-purpose computer and peripherals that, when programmed as described herein, may operate as a specially programmed computer in accordance with one or more embodiments of systems and methods for wellness program administration and evaluation.

FIG. 2 is a functional block diagram of an exemplary health information acquisition device in accordance with one or more embodiments of systems and methods for wellness program administration and evaluation.

FIG. 3 is a flow diagram illustrating an exemplary method of providing wellness to one or more individuals in accordance with one or more embodiments of systems and methods for wellness program administration and evaluation.

FIG. 4 is a flow diagram illustrating an exemplary method of determining physical and psychological health risk factors for one or more individuals in accordance with one or more embodiments of systems and methods for wellness program administration and evaluation.

FIG. 5 is a flow diagram illustrating an exemplary method for determining cost effectiveness of medical care in accordance with one or more embodiments of systems and methods for wellness program administration and evaluation.

FIG. 6 is a flow diagram illustrating an exemplary method for determining Individual Wellness Prescription in accordance with one or more embodiments of systems and methods for wellness program administration and evaluation.

FIG. 7 is an illustration of the graphical wellness prescription provided to each individual in accordance with one or more embodiments of systems and methods for wellness program administration and evaluation.

FIG. 8 is an exemplary ROI analysis in accordance with one or more embodiments of systems and methods for wellness program administration and evaluation.

FIG. 9 is a functional block diagram of the exemplary health information diagnosis and treatment device in accordance with one or more embodiments of systems and methods for wellness program administration and evaluation.

### DETAILED DESCRIPTION

Systems and methods for wellness program administration and evaluation will now be described. In the following exemplary description numerous specific details are set forth in order to provide a more thorough understanding of embodiments of systems and methods for wellness program administration and evaluation. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

In various embodiments, systems and methods for facilitating and conducting wellness programs are provided. In particular, information regarding participant characteristics, treatment costs, and efficacy of treatment can be combined to maximize performance of a wellness program using the systems and methods described herein. Further, relationships between psychological and physical conditions can be correlated and addressed in the context of a wellness program.

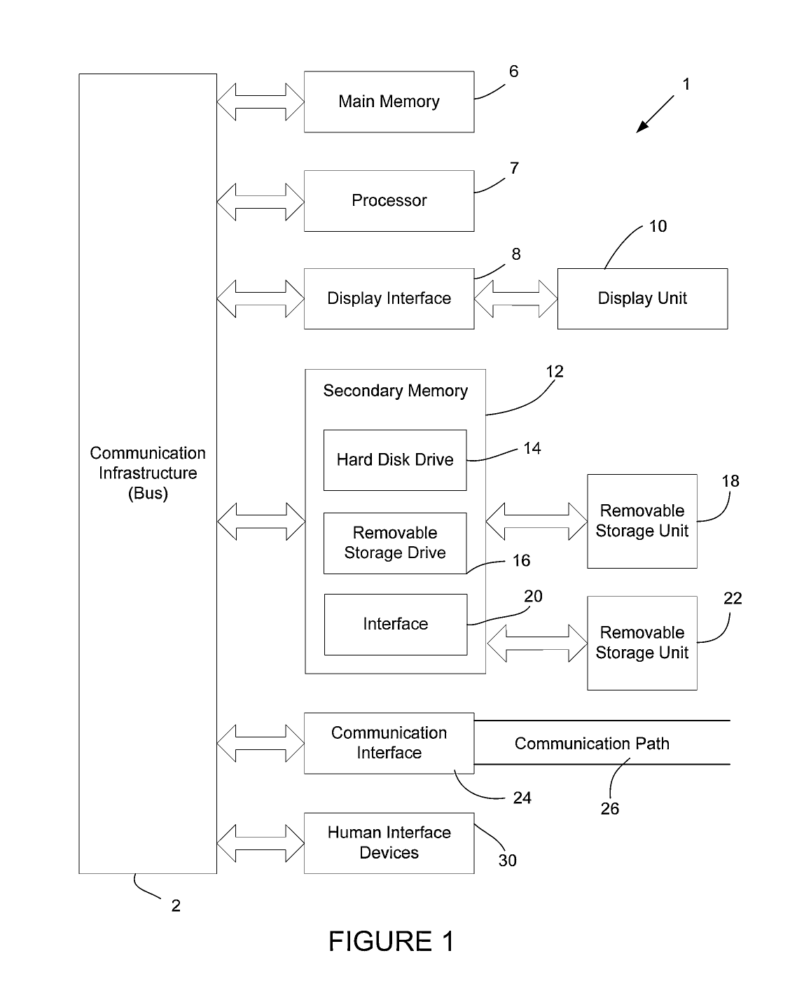

FIG. 1 is a functional block diagram of a general-purpose computer and peripherals that, when programmed as described herein, may operate as a specially programmed computer in accordance with one or more embodiments of systems and methods for wellness program administration and evaluation.

System 1 includes processor 7. Processor 7 may be coupled to bi-directional communication infrastructure 2 such as communication infrastructure system bus 2. Communication infrastructure 2 may generally be a system bus that provides an interface to the other components in the general-purpose computer system such as processor 7, main memory 6, display interface 8, secondary memory 12 and/or communication interface 24.

Main memory 6 may provide a computer readable medium for accessing and executed stored data and applications. Display interface 8 may communicate with display unit 10 that may be utilized to display outputs to the user of the specially-programmed computer system. Display unit 10 may comprise one or more monitors that may visually depict aspects of the computer program to the user. Main memory 6 and display interface 8 may be coupled to communication infrastructure 2, which may serve as the interface point to secondary memory 12 and communication interface 24. Secondary memory 12 may provide additional memory resources beyond main memory 6, and may generally function as a storage location for computer programs to be executed by processor 7. Either fixed or removable computer-readable media may serve as Secondary memory 12. Secondary memory 12 may comprise, for example, hard disk 14 and removable storage drive 16 that may have an associated removable storage unit 18. There may be multiple sources of secondary memory 12 and systems implementing the solutions described in this disclosure may be configured as needed to support the data storage requirements of the user and the methods described herein. Secondary memory 12 may also comprise interface 20 that serves as an interface point to additional storage such as removable storage unit 22. Numerous types of data storage devices may serve as repositories for data utilized by the specially programmed computer system. For example, magnetic, optical or magnetic-optical storage systems, or any other available mass storage technology that provides a repository for digital information may be used.

Communication interface 24 may be coupled to communication infrastructure 2 and may serve as a conduit for data destined for or received from communication path 26. A network interface card (NIC) is an example of the type of device that once coupled to communication infrastructure 2 may provide a mechanism for transporting data to communication path 26. Computer networks such Local Area Networks (LAN), Wide Area Networks (WAN), Wireless networks, optical networks, distributed networks, the Internet or any combination thereof are some examples of the type of communication paths that may be utilized by the specially program computer system. Communication path 26 may comprise any type of telecommunication network or interconnection fabric that can transport data to and from communication interface 24.

To facilitate user interaction with the specially programmed computer system, one or more human interface devices (HID) 30 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 7 to trigger one or more responses from the specially programmed computer are within the scope of the system disclosed herein.

While FIG. 1 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. In one or more embodiments, the system may also encompass parallel systems, multi-processor systems, multi-core processors, and/or any combination thereof. Where a virtual machine, process, device or otherwise performs substantially similarly to that of a physical computer system, such a virtual platform will also fall within the scope of disclosure provided herein, notwithstanding the description herein of a physical system such as that in FIG. 1.

One or more embodiments are configured to enable the specially programmed computer to take the input data given and transform it into a web-based UI by applying one or more of the methods and/or processes described herein. Thus the methods described herein are able to transform a stored component into a web UI, using the solution disclosed here to result in an output of the system as a web UI design support tool, using the specially programmed computer as described herein.

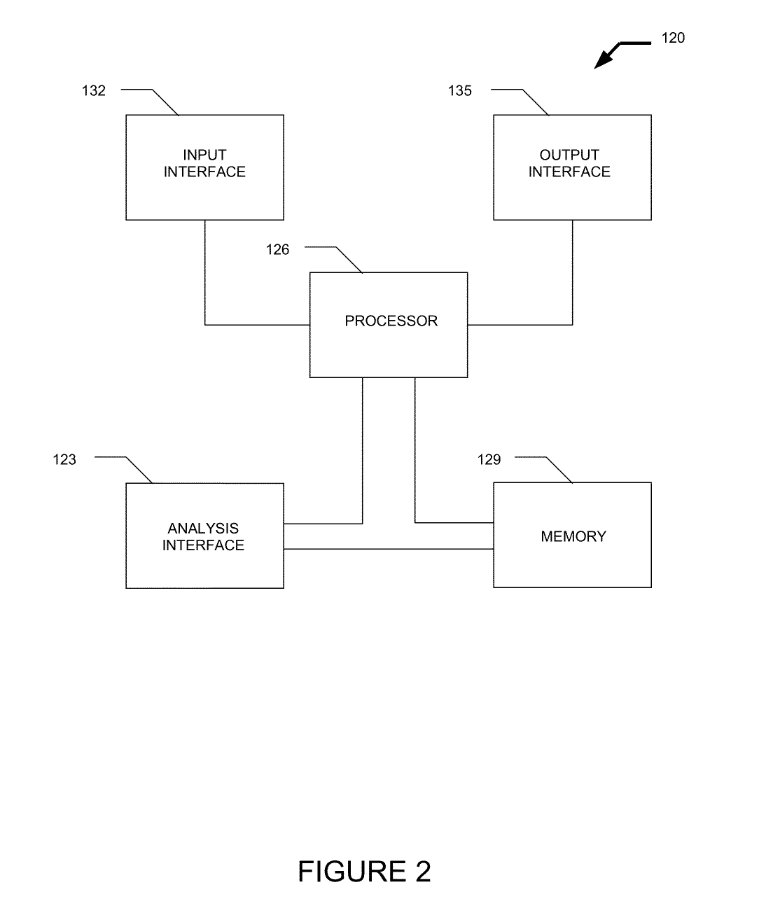

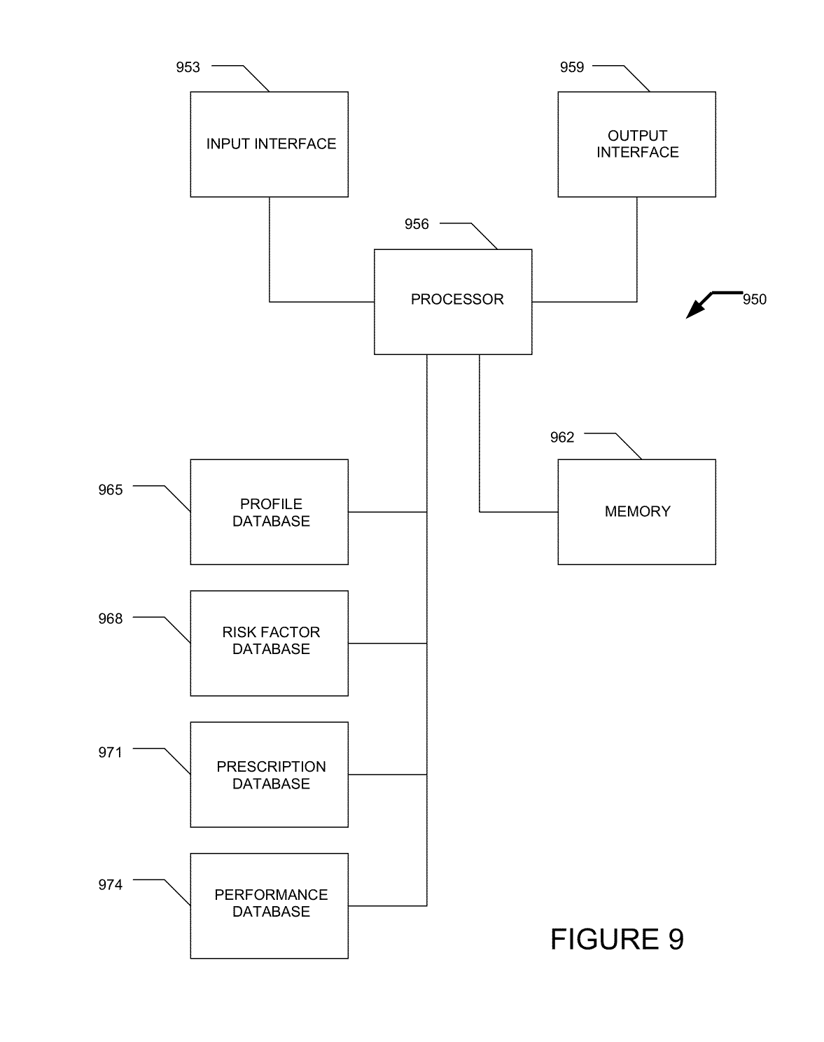

FIG. 9 is a functional block diagram of a computing apparatus 950. In one embodiment, the computing apparatus 950 facilitates the diagnosis and treatment of physical and psychological conditions. The computing apparatus 950 may also be used in the administration of a wellness program in a company or other setting. As described herein, the computing apparatus 950 may be used to maintain patient profiles, diagnose certain risk factors, determine treatment regimes, estimate the expected costs and benefits of those treatment regimes, monitor the progress of individuals as the treatment regime is administered, and update the diagnosis, treatment regimes, and cost estimates over time. The computing apparatus 950 comprises an input interface 953. Input interface 953 is configured to receive input from a user or from other devices such as a device as described with respect to FIG. 2. For example, medical information such as height, weight, age, blood chemistry information, or other information is received via the input interface 953. In one embodiment, the input interface comprises a user operated device such as a keyboard, keypad, mouse, touch screen, microphone, camera, or other device. In another embodiment, the input interface 953 comprises an interface for a storage device such as magnetic disk drive, solid state drive, optical drive, or other storage device. In another embodiment, input interface 953 comprises a network interface such as a wired or wireless receiver. The input interface 953 is configured to communicate received information to a processor 956. The processor 956 is configured to manipulate the received information as described herein. Further, the processor 956 is configured to control the operation of the computing apparatus 950. The processor 956 is also configured to output information from the computing apparatus 950 via an output interface 959.

The output interface 959 is configured to output information to a user or to another device. For example, in one embodiment, the output interface 959 is configured to provide a determined diagnosis to a healthcare professional or to a patient. In one embodiment, the output interface 959 comprises a device for communicating information directly to a user such as a display, a printer, a speaker, or other device. In another embodiment, the output interface 959 comprises a device for communicating information to a storage device such as a magnetic disk drive, solid state drive, optical drive, or other device. In another embodiment, the output interface comprises a network interface such as a wired or wireless transmitter.

The computing apparatus 950 further comprises a memory 962 in communication with the processor 956. The memory 962 provides storage for processor 956 during manipulation of information as described herein. The computing apparatus 950 also comprises a plurality of information databases such as a profile database 965, a risk factor database 968, a prescription database 971, and a performance database 974. The functionality of each of these databases is described further herein. In one embodiment, the functionality of the databases is implemented using the memory 962.

The profile database 965 stores information regarding one or more individuals. For purposes of explanation, information regarding a particular individual may be referred to as the particular individual's profile. Alternatively, information about the particular individual may be referred to as the individual's characteristics which may be collectively referred to as the profile for the individual. The profile database 965 stores one or more profiles for a corresponding one or more individuals. In one embodiment, the profile comprises medical information such as height, weight, age, blood glucose level, cholesterol level, blood pressure levels, or other information. In addition, the profile may comprise medical information reflecting variation in one or more characteristics over time. For example, the profile may store multiple indications of weight and other statistics as such characteristics are measured repeatedly over time. In another embodiment, the profile stores psychological information. For example, the profile may contain raw data from an objective psychological evaluation, recorded observations from medical professionals, or other information related to the individual's psychological state. The prolife may also contain multiple data points related to psychological condition as psychological measurements are taken over time.

In one embodiment, the profile also comprises information related to one or more risk factors for the individual. As described below, based on the physical and psychological information in the profile, the computing apparatus 950 may determine a likelihood that the particular individual will be affected by various chronic disease conditions. For example, based on the individual's excessive weight (Body Mass Index of 30 or greater), high blood pressure (140/90), and other factors, the computing apparatus 950 may determine that the individual possesses a risk, e.g., three times greater risk of heart disease based upon research studies that compare populations of individuals who possess or have possessed those same biometric measures. All such measurement data and their relative weights with regard to a propensity for any chronic illness is located with the risk factor database 968. This chance or likelihood of experiencing a condition may be referred to as a risk factor. Concurrently, a risk factor may refer to the likelihood that the individual will incur expenses resulting from a particular condition in a certain period of time. For example, the individual may have a 60% chance of missing work, being unproductive at work, visiting a doctor, or incurring some other cost in the next year as a result of a particular condition. In another embodiment, rather than being expressed as a numerical percentage, the possibility of contracting a chronic disease, such as heart disease, is comprised of one or more risk categories. For example, a high risk category and a low risk category may be defined for one or more conditions. Each category may represent a more specific likelihood that the individual will experience a particular condition or incur expenses related to the condition. The specific likelihood threshold for the one or more categories may be determined by the presence of one or more risk factors or categories of risk factors. The individual's profile may contain information regarding the risk factors determined for the individual. The information regarding risk factors may also be stored over time as the physical and psychological risk factors vary in time with a given individual. In this manner, reduction and increases in various risk factors for the individual may be tracked and analyzed.

The profile may also comprise information related to one or more prescriptions for the individual. As described below, based on the physical and psychological risk factors information in the profile, the computing apparatus 950 may determine one or more prescriptions for the individual. For example, based on a high risk determination for depression and other information in the profile, the computing apparatus 950 may determine a prescription containing regular counseling sessions with a psychotherapist. The profile may contain information and notes related to the prescribed treatment. The prescription information may also be stored over time as the prescribed treatment changes in response to changes in the individual's physical state, psychological state, and risk factors.

The profile may also comprise information related to the individual's performance. This information may include subjective or objective observations of the individual's compliance with prescribed treatment. For example, the profile may indicate how many sessions with a psychotherapist were attended and missed. Similarly, the profile may comprise information regarding the cost of administering the prescribed treatment as well as costs associated with one or more conditions. As described below, the performance information in the profile may be used in conjunction with other information in the profile to modify prescriptions, to determine cost effectiveness of treatment, or for other reasons. The performance information may also comprise indications of changes in risk factors over time.

The computing apparatus 950 may further comprise a risk factor database 968. As described above, elevated risk factor measurements are highly correlated to a likelihood that the person will be affected by a chronic illness. Risk factor database 968 is comprised of the set of measures taken on any individual regarding the established set of physical and psychological human health risk factors. The major physical and psychological risk factors can be expressed as: lack of exercise, inadequate nutrition, excessive alcohol consumption, smoking, disregard for personal safety, excessive body weight, high blood pressure, high blood glucose, high cholesterol, elevated triglycerides, chronic stress, persistent anxiety, depression and substance addictions. These major risk factors have been determined through exhaustive research study by leading private and public health research institutes. In one embodiment, the risk factor database 968 comprises, for one or more conditions, a set of weighting values which relate particular physical and psychological characteristics to a particular condition. For example, smoking places an individual at more than five times greater risk of heart disease than an individual who does not smoke. Additionally, a complete lack of exercise places an individual at an almost one and half times greater risk of heart disease than someone who exercises five or more times per week. In one example, this correlation is expressed as a mathematical equation:

(Smoking_{RF})×(5.48_{WF})+(Inactivity_{RF})×(1.41_{WF})=6.89×risk of Heart Disease

According to the equation, the relative risk factor for heart disease (heart disease) is determined by summing the product of a weighted value (WF) of smoking (RF) and the weighted factor (WF) of Inactivity (RF). In other examples, the relationship between a particular risk factor and its contributing characteristics are non-linear, include composite weighting factors for combinations of patient characteristics, or include additional information for normalizing patient characteristics, e.g., height adjusted weight. The risk factor database 968 may comprise one or more of weighting factors representative of correlations between patient characteristics and various conditions. The risk factor database 968 may also comprise one or more formulas for determining a risk factor based, at least in part, on patient characteristics and weighting factors.

In another embodiment, risk factors are expressed in terms of one or more severity categories. For example, two categories such as high risk and low risk may be defined. The risk factor database 968 may comprise information for determining a severity category for one or more conditions for the individual based on the characteristics of the individual. In one embodiment, one or more threshold values for each risk category for each condition may be stored in the risk factor database. The computing apparatus 950 may determine a risk category for individual with respect to a particular condition based upon the threshold values and the characteristics of the individual. For example, designations of risk for any one risk factor can be stated as “ideal”, “borderline” or “needs improvement” with needs improvement indicating that the individual has met the conditions that place him in the high risk category regarding that particular risk factor. These determinations may be represented as a logical equation:

(Weight_{RAW}>30_{BMI})=Obesity (needs improvement/high risk)

According to the equation, a patient is in the high risk category for Obesity if the patient's measured weight (Weight_{RAW}) is greater the high risk threshold of 30 (BMI). Equations for each condition and each risk category may also be stored in the risk factor database 968. Equations for other conditions and characteristics may use other logical operators and combinations. Thresholds for each condition/characteristic/category may also be stored in the risk factor database.

The various thresholds and weighting factors described herein may be determined analytically from reported data descriptive of patient characteristics and actual patient outcomes using data mining or machine decision engine techniques.

Computing apparatus 950 may also comprise a prescription database 71. Prescription database 971 may comprise information regarding behavior changes that will positively impact the health risk profile of an individual. For example, the prescription database 971 may contain a recommendation of periodic psychotherapy sessions for patients shown to be at high risk for chronic stress syndrome. Since chronic stress syndrome has a deleterious effect on bodily organs and blood chemistry an individual wellness prescription regarding high levels of stress would, therefore, indicate the need for the individual to engage in psychotherapeutic sessions designed to alleviate stress. In one embodiment, the prescription database 971 comprises multiple potential treatments for each condition. As described above, the risk for chronic disease may be determined based on multiple patient characteristics. In one embodiment, the prescription database 971 comprises one or more potential prescriptions associated with each patient characteristic used to determine the risk factor for the particular condition. For example, if the risk factor for heart disease is determined based upon weight and cholesterol, the prescription database may comprise one or more prescriptions related to weight and one or more prescriptions relating to cholesterol. In this manner, if a particular patient characteristic, e.g., weight, contributes more significantly to the determination of an elevated risk factor for a condition, a prescription related to that particular characteristic may be determined rather than a more generic prescription related to the condition generally.

The computing apparatus 950 may also comprise a performance database 974. Performance database 974 may comprise information regarding the efficacy and cost of prescriptions for one or more risk factors. In one example, the performance database 974 may comprise information related to a depression risk factor. For one or more prescriptions for lowering the depression risk factor, the performance database may comprise information describing the likelihood that the one or more prescriptions will lower the risk factor. This likelihood may be expressed as an average percentage decrease in a numerical risk factor for patients using a particular prescription. This likelihood may also be expressed as a percentage chance that patients using the prescription will change from a high risk category to a non high risk category. In addition to this type of efficacy information related to particular risk factors and prescriptions, the performance database 974 may also comprise cost information associated with the one or more prescriptions and with the one or more risk factors. For example, the performance database 974 may comprise information on the price of treating depression using diet control. The depression database may also comprise information on the cost, either to the employer directly through expenditures on items such as health benefits or indirectly through effects such as decreased productivity. As described below, the combination of cost and efficacy information may be used in selecting prescriptions. Further, this information may be used to predict and verify the return on investment into a wellness program. Information in the performance database may be determined from historical information via data gathering and analysis techniques such as machine learning. In addition, the information in the performance database may be updated with information from individuals participating in a wellness program making use of the computing apparatus 950. In this manner, the accuracy of effectiveness, costs and pricing information can be improved.

As described herein, the processing and determining of risk factors, prescriptions, and performance information may be performed by the processor 956 in conjunction one or more of the other described features of processing apparatus 950. Advantageously, the computing apparatus 950 may facilitate a wellness program which can determine risk factors for individuals, determine prescriptions based on the risk factors and characteristics of the individuals, and track the effectiveness of the prescriptions. In this manner, the wellness of participants may be enhanced and, when implemented in a workplace environment, the productivity and profitability of the workforce may be increased.

The processor 956 may be implemented with one or more general-purpose and/or special-purpose processors. Examples include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

One or more processors in the processing apparatus may execute software. Software shall be construed broadly to mean instructions, instruction sets, code, code segments, program code, programs, subprograms, software modules, applications, software applications, software packages, routines, subroutines, objects, executables, threads of execution, procedures, functions, rules bases, etc., whether referred to as software, firmware, middleware, microcode, hardware description language, or otherwise.

The software may reside on a computer-readable medium. A computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, or any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials.

FIG. 2 is a functional block diagram of an exemplary health information acquisition device in accordance with one or more embodiments of systems and methods for wellness program administration and evaluation.

FIG. 2 illustrates a medical information acquisition apparatus 120. In one embodiment, the apparatus 120 acquires individual or patient characteristics for use in a wellness program as described herein. Apparatus 120 comprises an input interface 132 for receiving information. In one embodiment, the input interface 132 may comprise the input interface 53 of FIG. 1. The input interface 132, may also comprise a user input device such as a keyboard, keypad, touch screen, or other input device. In this manner a user, such as a psychotherapist, may input patient characteristics into the apparatus. In another embodiment the input interface comprises a communication interface such as an antenna or wired network interface configured to receive information from another device. In another embodiment, the input interface comprises a media reading interface such as an optical media drive, a magnetic media drive, or other interface for receiving information from media. Information received at the input interface 132 is communicated to the processor 126. The processor 126 may be similar to the processor 56 of FIG. 1. The processor 126 may be configured to further process the received information or to store the received information in memory 129. The memory 129 may be similar to the memory 62 of FIG. 1. Further, the memory 129 may comprise the databases 65, 68, 71, and 74 of FIG. 1. The processor 126 may also be configured to communicate received information or information stored in the memory 129 to a person or to another device via the output interface 135. The output interface 135 may be similar to the output interface 59 of FIG. 1. The output interface 135 may comprise an output device such as a screen, a speaker, or other device for communicating information directly to a user. In another embodiment, the output interface 135 comprises an interface such as an antenna or a wired network interface for communicating with another device. In another embodiment, the output interface comprises a media writing interface such as an optical media writer, a magnetic media writer, or other media writing device.

The apparatus 123 also comprises an analysis interface 123. In one embodiment the analysis interface 123 is used to directly measure patient characteristics. For example, the analysis interface may comprise a photonic analysis device or other device used to directly measure biochemical/biometric characteristics of a patient. Information from the analysis interface 123 may be communicated to the processor 126 for further processing or for storage in the memory 129.

In one embodiment, the apparatus 120 is implemented as hand held device for use by individuals such as psychotherapists to administer a wellness program. The process of using such a handheld device for administration of a wellness program will be described in greater detail below.

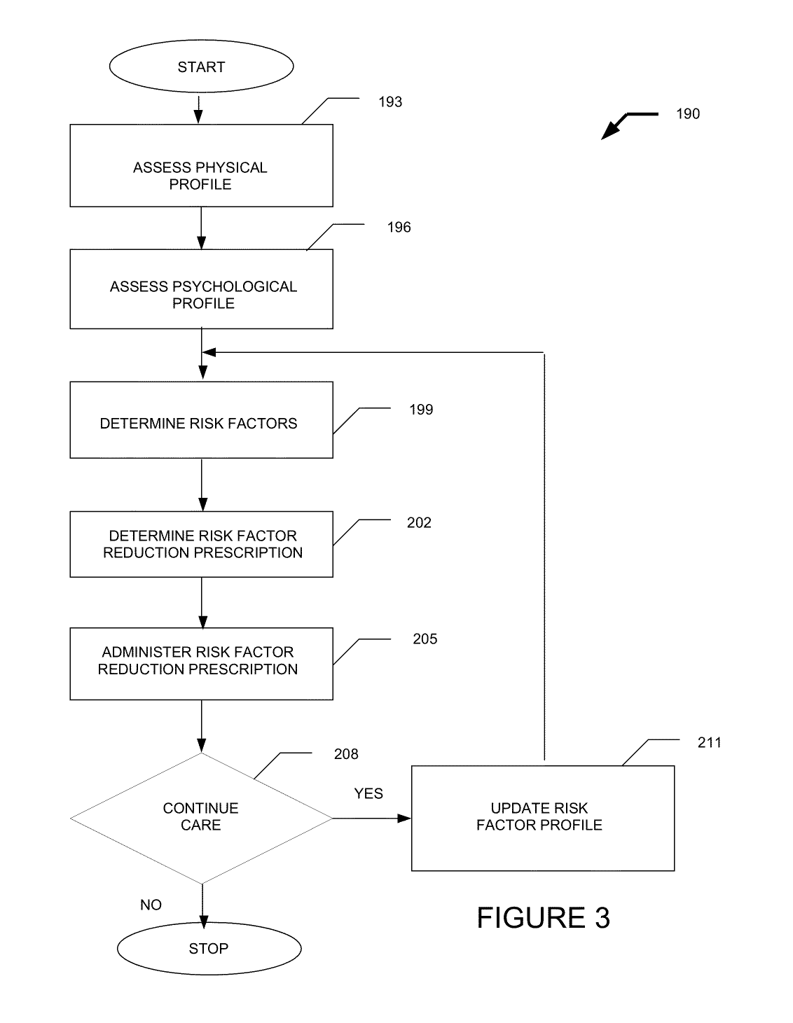

FIG. 3 is a flow diagram illustrating an exemplary method of providing wellness to one or more individuals in accordance with one or more embodiments of systems and methods for wellness program administration and evaluation.

FIG. 3 illustrates a method 190 of treating a health condition. In one embodiment, the method 190 may be implemented using an apparatus such as the apparatus 120 described above. At block 193, a physical profile for a patient is assessed. In one embodiment this may comprise measuring physical biometric/biochemical characteristics of the patient. For example, an administrator, such as a psychotherapist or other wellness program administrator could meet with the patient and measure certain physical characteristics such as weight or height. These measurements may be recorded or input into a device such as the apparatus 120. The administrator may also perform other tests such as blood glucose tests, triglycerides or other tests using a device such as the apparatus 120 of FIG. 2. In another embodiment, the administrator may also draw blood or collect other biological samples for subsequent processing. Information derived from any or all of these measurements may be read from the device such as the apparatus 120 of FIG. 2.

At block 196, a psychological profile for the patient is assessed. In one embodiment, the administrator administers a psychological evaluation of the patient. For example, the administrator may provide the patient with a written questionnaire for completion. In another embodiment, the administrator may conduct an oral examination of the patient. The raw results or processed results of the psychological evaluation may be entered into a device such as the apparatus 120 of FIG. 2.

At block 199, an apparatus, such as the computing apparatus 50 of FIG. 1 or the apparatus 120 of FIG. 2 is configured to determine risk factors for the patient based upon the physical and psychological profiles described above. As described herein, the process of determining risk factors may comprise comparing the profile information of the patient against a catalogue of previously collected health risk factor information and determining a risk factor or risk category for the patient with respect to one or more conditions. For example, the apparatus may be configured to identify a set of patients who share similar characteristics. The apparatus may be further configured to determine the actual rate of incidence for particular conditions among similar patient profiles. This effective rate of incidence may be imputed to the patient or may be used to derive a risk factor for the patient with respect to the particular conditions. In another embodiment, the apparatus may be configured to use correlations between certain characteristics and certain conditions to determine risk factors for the patient with respect to the conditions as described above.

At block 202, an apparatus, such as the computing apparatus 50 of FIG. 1 or the apparatus 120 of FIG. 2 is configured to determine one or more prescriptions for the patient based upon the profile information and the determined risk factors. As described herein, the process of determining a prescription may be comprised by analyzing the risk factor profile information of the patient. For example, the apparatus may be configured to identify a set of patients with similar characteristics who were subjected to different prescriptions. The apparatus may be further configured to identify the effectiveness of the different prescriptions in lowering the risk factor for the set of similar patients. The apparatus may also be configured to determine the cost of administering each potential prescription and may use such cost information in determining the effectiveness of various prescriptions and in selecting one or more prescriptions for the patient. The apparatus may also be configured to receive and use input from the administrator, e.g., a psychotherapist, in determining a prescription. For example, the apparatus may provide the administrator with the expected cost and effectiveness of one or more prescriptions. The psychotherapist may then select a prescription based on the output of the apparatus.

At the block 205, one or more selected risk factor reduction prescriptions are administered to the patient. For example, the selected prescription for obesity may comprise one or more guidance or therapy sessions. These sessions may be conducted by a psychotherapist or other wellness program administrator. Any measurements, observations, or other information resulting from administration of the prescription may be input into the apparatus described above for the purpose of tracking progress and adjusting the prescriptions or risk factors of the patient.

At decision block 208, a determination is made as to whether or not to continue administration of the wellness program. If care is not continued, the process 190 concludes. For example, if the wellness program is administered by an employer and the patient is an employee who leaves employment, the program for that patient may terminate. However, if care is continued, the method proceeds to block 211.

At block 211, the profile of the patient is updated. For example, measurements and data gathering consistent with the processes described with respect to blocks 193 and 196 may be performed. In another embodiment, a subset or a complete set of the measurements taken for a patient's initial profile assessment are re-retaken. Any other information regarding patient characteristics may also be entered into the patient's profile. After the profile is updated, the method proceeds to determine an updated set of risk factors based on the updated profile. The process 190 may proceed iteratively until care is discontinued.

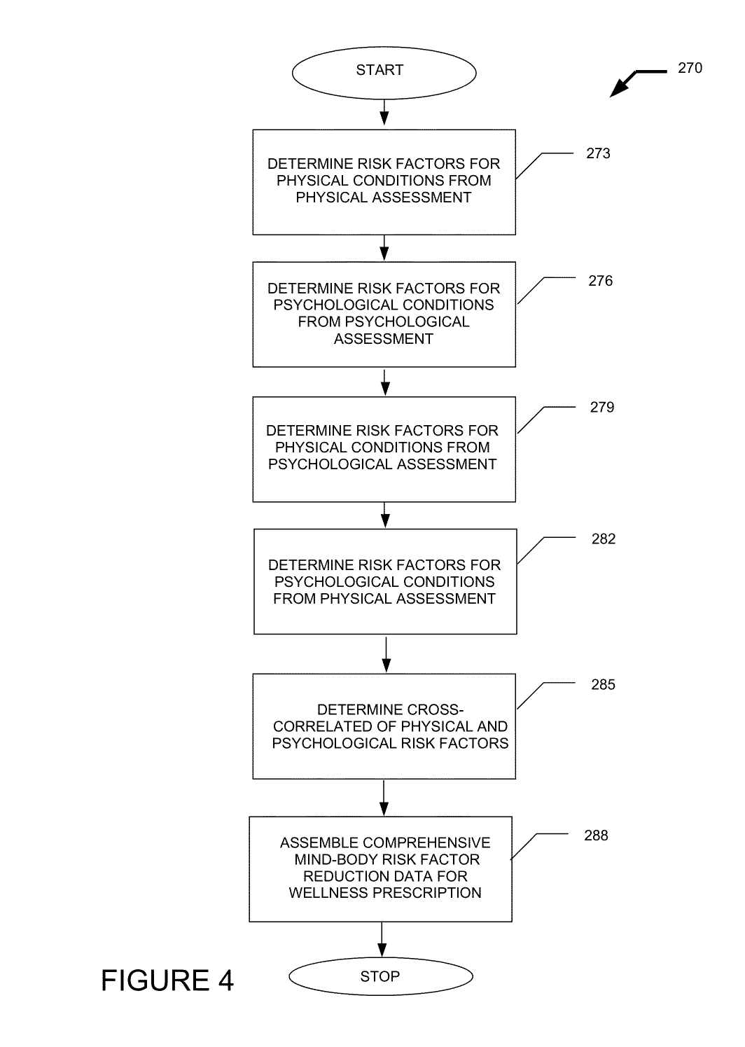

FIG. 4 is a flow diagram illustrating an exemplary method of determining physical and psychological health risk factors for one or more individuals in accordance with one or more embodiments of systems and methods for wellness program administration and evaluation.

FIG. 4 illustrates a method 270 for determining one or more risk factors for a patient and how physical risk factors cross-correlate with psychological risk factors as well as the reverse resulting in physical risk factors adversely effecting psychological conditions and psychological risk factors resulting in adverse physical conditions. In one embodiment, the method 270 may be implemented on an apparatus such as the apparatus 50 of FIG. 1 and/or in conjunction with the apparatus 120 of FIG. 2. At block 273, the apparatus determines risk factors for physical conditions based upon physical characteristics in a patient's profile. For example, the apparatus 120 may used to collect data to determine a risk factor for a physical condition such as obesity based upon physical characteristics such as cholesterol levels, glucose levels, or other physical indicia. In another embodiment, the apparatus is configured to determine the contribution of physical characteristics to risk factors for physical conditions.

In block 276, the apparatus determines risk factors for psychological conditions based upon psychological information in the patient's profile. For example, the apparatus may be configured to determine a risk factor for depression based upon answers to an objective psychological examination administered by a psychotherapist. In another embodiment, the apparatus may be configured to determine the contribution of psychological characteristics to risk factors for psychological conditions.

In block 279, the apparatus determines risk factors for physical conditions based on psychological characteristics in the patient's profile. For example, the apparatus may be configured to determine a risk factor for obesity based upon answers to an objective psychological examination administered by a psychotherapist. In another embodiment, the apparatus may be configured to determine the contribution of psychological characteristics to risk factors for physical conditions.

In block 282, the apparatus determines risk factors for psychological conditions based on physical characteristics in the patient's profile. For example, the apparatus may be configured to determine a risk factor for depression based upon the patient's weight, age or other physical indicia. In another embodiment, the apparatus may be configured to determine the contribution of psychological characteristics to risk factors for physical conditions.

In block 285, software algorithms designed and working with the processor 56 and associated profile database 65 and risk factor database 68 in conjunction with data gathered in apparatuses 273, 276, 279 and 282 determine how any patient physical anomaly and/or any patient psychological anomaly will impact each other to affect the generation of the wellness prescription depicted in apparatus 202 of method 190.

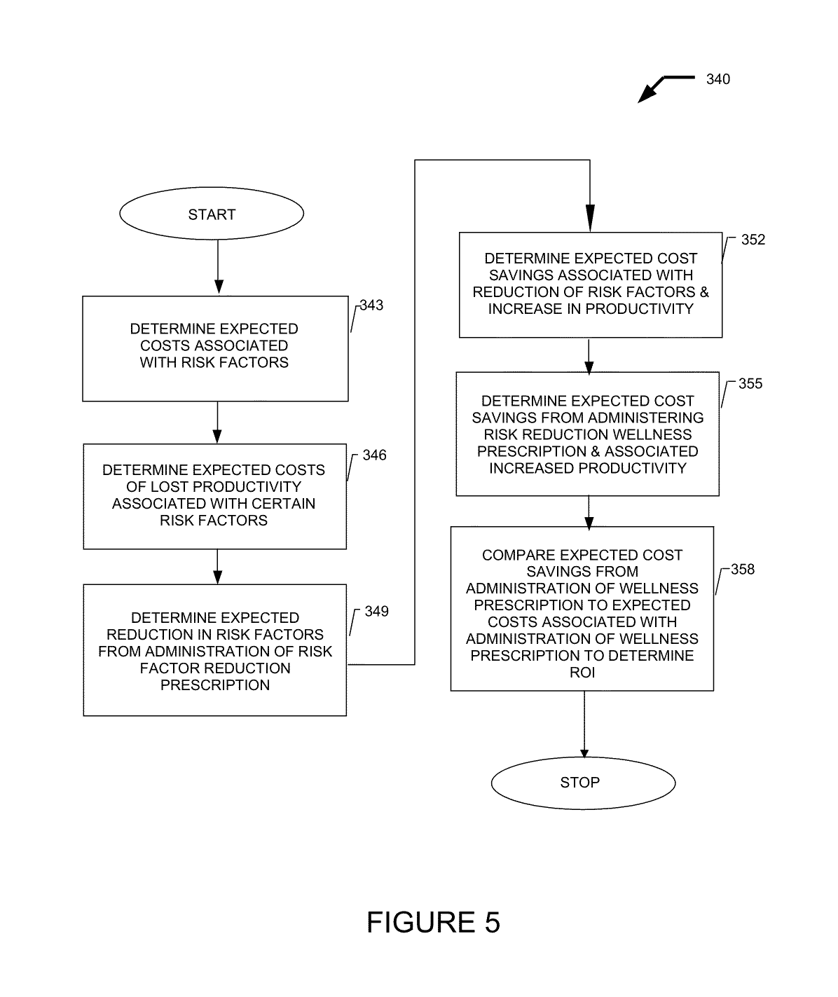

FIG. 5 is a flow diagram illustrating an exemplary method for determining cost effectiveness of medical care in accordance with one or more embodiments of systems and methods for wellness program administration and evaluation.

FIG. 5 illustrates a method 340 for determining cost effectiveness of a wellness program. From an individual or corporate perspective this concept can also be expressed as their return on investment. In one embodiment, the method 340 may be implemented on an apparatus such as the apparatus 50 of FIG. 1 or the apparatus 120 of FIG. 2. At block 343, the apparatus calculates standard healthcare costs associated with one or more risk factors. At step 346, the apparatus determines the expected costs associated with the patient's one or more risk factors relative to the patient's productivity levels as measured primarily in a work setting. For example, the apparatus may determine based on historical study data that, on average, a person in the high risk category for a condition such as depression costs an employer a certain dollar amount in terms of medical expenditures and lost productivity. This additional cost may be considered an expected cost associated with the high risk category for a condition.

Block 349 calculates the expected reduction in risk factors, over specific periods of time, for each patient provided a wellness prescription. For example, an obese person who properly performs the prescriptions activities can expect to move from the high risk to the low risk status within a year of starting the program. Block 349 helps individuals and employers understand a progress timeline for each person who receives a wellness prescription.

At block 352 data from method 190 is utilized to provide projected calculations regarding possible savings in both health care and productivity costs that adherence the wellness prescription can generate and uses data from block 349. That data would include all risk factor data, average employee wage, absenteeism rates, objective and subjective measures of productivity among other data points. For example, if an individual has diabetes the additional cost associated with that condition are compared to cost data for those not afflicted with the condition illustrating the additional costs associated with the individual diabetes.

At block 355, the apparatus is configured to determine an expected cost savings via the reduction in risk factors resulting from the administration of one or more wellness prescriptions and the associated reduction in health risk factors, decreases in absenteeism and increases in productivity. For example, by administering psychotherapy, patients might experience a decrease in the risk factor for obesity. The reduction may be determined as a change in risk category, such as from high risk to low risk, which can be correlated with a reduction of health care expenses and monetary gains associated with decreased absenteeism and increased productivity as a result of the change from high risk to low risk.

At block 358, the apparatus determines the expected cost savings from administering the wellness prescription to the patient. For example, the apparatus may determine the difference between the expected cost incurred by an employee with a risk factor where no change in risk status has occurred and the expected cost savings associated with the reduction of that risk factor after the patient has been subjected to a prescription. This difference may be referenced as an expected saving from administering the prescription as well as a return on investment for the administering of the prescription. Advantageously, the expected return on investment may be used to determine the desirability of administering a wellness program.

In one embodiment, the information used at each stage of the method 340 may be updated as new information becomes available either through the introduction of new research data or the actual comparison of year-over-year cost data available through the ongoing activities of the wellness program. For example, the costs associated with particular risk factors can be updated as time progresses to reflect the actual costs incurred rather than the predicted costs. Similarly, the expected costs of administering particular prescriptions can be updated as the costs of administration are determined. Also, the actual reductions in risk factors may be updated using newly acquired patient information to reflect the efficacy of the provided prescriptions. Using updated information and information collected from patients, the expected return on investment can be compared to an actual return on investment. This actual return on investment may also be used in determining the desirability of administering a wellness program.

As described above, it may be desirable to use a psychotherapist to administer a wellness program as described herein. In one embodiment the significant cost of using psychotherapists to administer a wellness program can be offset using the methods and systems described herein to save time and resources. In addition, it may be advantageous to use psychotherapist interns to administer a wellness program as described herein. Aspiring therapists engage in a course of study (Master's in Counseling Psychology, Doctorate in Clinical Psychology, etc.) and complete the course work over time. During and after that time period the graduates must complete, depending on the jurisdiction, 3000 hours of individual, family, couples and child therapy to get licensed to practice on their own. Such requirements may take 3 years or longer to complete. In the meantime the intern therapist is in an “economic limbo.” They cannot earn as much as a licensed therapist and often cannot attract enough clients to provide a sustaining income. Yet, these are highly educated, highly skilled therapists—especially those who have achieved 1000 hours or more of “face time” with clients. In one embodiment the wellness programs described herein may be administered by interns. Advantageously, the interns may be paid a modest stipend and employed at work sites to actually engage in wellness guidance with patients to help them reach their optimum physical and mental health. The therapists might be paid a third of what a wellness coach would demand and are receive the chance to accumulate hours (rapidly) towards licensure. Economically both the therapists and the individual or employer wins. This difference in wellness provider compensation allows wellness organization to provide a high therapist-to-employee ratio ensuring more interactions with the employee increasing the likelihood of positive change by at least an order of magnitude.

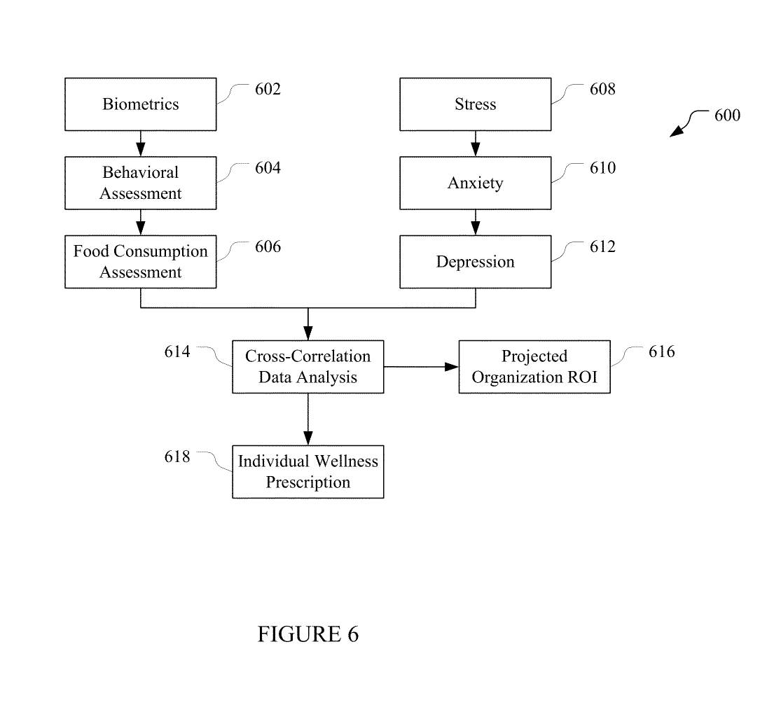

FIG. 6 is a flow diagram illustrating an exemplary system 600 for determining Individual Wellness Prescription in accordance with one or more embodiments of systems and methods for wellness program administration and evaluation. System 600 is based on a comprehensive understanding of how to positively impact the rate of healthy lifestyle adoption using the holistic mind-body approach. On the one side is the physical assessment comprising Biometric data collection 602, Behavioral Assessment 604, and Food Consumption Assessment 606. On the other side is the emotional assessment comprising Stress Assessment 608, Anxiety Assessment 610, and Depression Assessment 612. The effects of physical health on mental health and the reverse were identified and woven into the design. Samples of these effects are illustrated in Tables 1 and 2.

TABLE 1
Medical Disorders That Can Cause Mental Disorders (Emotional/Behavioral)

| | Emotional/Behavioral Symptoms | | | | | | | | | | |
|---|---|---|---|---|---|---|---|---|---|---|---|
| | Relative | Depres- | | | | OCD-like | Labile | With- | Cata- | | Hyper- |
| | Frequency | sion | Mania | Anxiety | Panic | Behaviors | Emotions | drawal | tonia | Insomnia | somnia |
| Adrenal | U | x | | x | | | | x | | | |
| Insufficiency | | | | | | | | | | | |
| AIDS | F | x | x | x | | | | x | | | |
| Altitude | U | | | | x | | | | | x | |
| Amyotrophic | U | x | | | | | | | | | |
| Lateral | | | | | | | | | | | |
| Sclerosis | | | | | | | | | | | |
| Antidiuretic | F | | | | | | | | | | |
| Excess | | | | | | | | | | | |
| Brain Abscess | U | | | | | | | | | | |
| Brain Tumor | F | x | x | | | | x | | | | |
| Cancer | C | x | | x | x | | | | | | |
| Carcinoid | F | | | | | | | | | | |
| Cardiac | C | | | x | | | | | | | |
| Arrhythmia | | | | | | | | | | | |
| Cerebrovascular | C | x | x | x | | | x | | | x | |
| Disease | | | | | | | | | | | |
| Chronic | C | x | | x | x | | | | | x | |
| Obstructive | | | | | | | | | | | |
| Lung Disease | | | | | | | | | | | |
| Congestive | C | x | | x | x | | | | | x | |
| Heart | | | | | | | | | | | |
| Failure | | | | | | | | | | | |
| Cryptococcosis | F | | x | | | | | | | | |
| Cushing's | F | x | x | x | | | | | | x | |
| Deafness | C | | | x | | | | | | | |
| Diabetes | C | x | | x | x | | | | | | |
| Mellitus | | | | | | | | | | | |
| Epilepsy | C | x | x | | | | | | x | | |
| Fibromyalgia | C | x | | x | x | | | | | | |
| Head Trauma | C | x | x | x | | | | | | x | |
| Herpes | U | | | x | | | | | x | | |
| Encephalitis | | | | | | | | | | | |
| Homocystinuria | U | | | | | | | | x | | |
| Huntington's | U | x | x | | | | | x | | | |
| Hyperparathyroidism | F | x | | x | | | x | | x | | |
| Hypertensive | F | | | | | | | | | | |
| encephalopathy | | | | | | | | | | | |
| Hyperthyroidism | C | x | | x | x | | x | | | x | |
| Hypoparathyroidism | U | x | | x | | x | x | x | | | |
| Hypothyroidism | C | x | | | | | | x | | | |
| Kidney Failure | F | x | | | | | | | | x | |
| Kleinfelter's | F | x | | | | | | | | | |
| Liver Failure | C | x | | | | x | x | | | | |
| Lyme Disease | F | x | | x | x | | | | | x | |
| Meniere's | F | x | | x | x | | | | | | |
| Menopause | N | x | | x | | | | | | x | |
| Migraine | C | x | | | | | | | | | |
| Mitral Valve | C | | | x | x | | | | | | |
| Prolapse | | | | | | | | | | | |
| Multiple | F | x | x | | | | x | | | | |
| Sclerosis | | | | | | | | | | | |
| Myasthenia | F | | | x | | | | | | | |
| Gravis | | | | | | | | | | | |
| Neurocutaneous | F | x | | x | | | | | x | | |
| Diseases | | | | | | | | | | | |
| Normal-pressure | F | x | | | | | | | | | |
| hydrocephalus | | | | | | | | | | | |
| Parkinson's | F | x | | x | | | | | | | |
| Pellagra | R | x | | x | | | | | | x | |
| Pernicious | C | x | x | | | | | | | | |
| Anemia | | | | | | | | | | | |
| Pheochromocytoma | U | | | x | x | | | | | | |
| Pneumonia | C | | | x | x | | | | | | |
| Porphyria | U | x | x | x | | | | | | x | |
| Postoperative | F | x | | x | | | | | | | |
| States | | | | | | | | | | | |
| Premenstrual | C | x | | x | | | x | | | x | x |
| Syndrome | | | | | | | | | | | |
| Prion Disease | R | | | x | | | x | | | | |
| Progressive | U | x | | x | | | x | | | | |
| Supranuclear | | | | | | | | | | | |
| Palsy | | | | | | | | | | | |
| Protein Energy | C | x | | | | | | | | | |
| Malnutrition | | | | | | | | | | | |
| Pulmonary | F | | | x | | | | | | | |
| Thromboembolism | | | | | | | | | | | |
| Rheumatoid | C | x | | | | | | | | x | |
| Arthritis | | | | | | | | | | | |
| Sickle Cell | F | x | | | | | | | | | |
| Disease | | | | | | | | | | | |
| Sleep Apnea | C | x | | x | | | | | | x | |
| Syphilis | U | | x | | | | | | | x | |
| Systemic | C | x | | x | x | x | | | | | |
| Infection | | | | | | | | | | | |
| Systemic Lupus | F | x | | | | | | | | | |
| Erythematosus | | | | | | | | | | | |
| Thiamine | F | | | x | | | | | | | |
| Deficiency | | | | | | | | | | | |
| Wilson's | U | x | | | | | | | x | | |

| | Emotional/Behavioral Symptoms | | | | | | | | |
|---|---|---|---|---|---|---|---|---|---|
| | | | Depersonal- | | | | | | |
| | Halluci- | | ization/ | | Poor | Suicidal | PTSD | | Kluver- |
| | nations | Delusions | Derealization | Deja vu | Judgment | Ideas | Symptoms | Flushing | Bucy |
| Adrenal | x | x | | | | x | | | |
| Insufficiency | | | | | | | | | |
| AIDS | x | x | | | | x | | | |
| Altitude | x | x | | | x | | | | |
| Amyotrophic | | | | | | | | | |
| Lateral | | | | | | | | | |
| Sclerosis | | | | | | | | | |
| Antidiuretic | x | x | | | | | | | |
| Excess | | | | | | | | | |
| Brain Abscess | | | | | | | | | |
| Brain Tumor | x | x | x | x | | | | | |
| Cancer | | | | | | x | x | | |
| Carcinoid | | | | | | | | x | |
| Cardiac | | | | | | | | | |
| Arrhythmia | | | | | | | | | |
| Cerebrovascular | x | x | | | x | x | | | |
| Disease | | | | | | | | | |
| Chronic | x | | | | x | x | | | |
| Obstructive | | | | | | | | | |
| Lung Disease | | | | | | | | | |
| Congestive | x | | | | | | | | |
| Heart | | | | | | | | | |
| Failure | | | | | | | | | |
| Cryptococcosis | x | | | | | | | | |
| Cushing's | x | x | | | | x | | | |
| Deafness | x | x | | | | | | | |
| Diabetes | | | | | | | | | |
| Mellitus | | | | | | | | | |
| Epilepsy | x | x | | | | x | | | |
| Fibromyalgia | | | | | | | | | |
| Head Trauma | x | | | | | | | | |
| Herpes | x | | | | | | | | x |
| Encephalitis | | | | | | | | | |
| Homocystinuria | | | | | | | | | |
| Huntington's | x | x | | | | | | | |
| Hyperparathyroidism | x | x | | | | x | | | |
| Hypertensive | | x | | | | | | | |
| encephalopathy | | | | | | | | | |
| Hyperthyroidism | x | | | | | | | | |
| Hypoparathyroidism | x | x | | | | | | | |
| Hypothyroidism | x | x | | | | x | | | |
| Kidney Failure | x | | | | x | x | | | |
| Kleinfelter's | x | | | | | | | | |
| Liver Failure | | | | | | | | | |
| Lyme Disease | x | x | | | | | | | |
| Meniere's | | | | | | | | | |
| Menopause | | | | | | | | | |
| Migraine | | | | | | | | | |
| Mitral Valve | | | | | | | | | |
| Prolapse | | | | | | | | | |
| Multiple | | | | | x | | | | |
| Sclerosis | | | | | | | | | |
| Myasthenia | | | | | | | | | |
| Gravis | | | | | | | | | |
| Neurocutaneous | | | | | | | | | |
| Diseases | | | | | | | | | |
| Normal-pressure | x | x | | | | | | | |
| hydrocephalus | | | | | | | | | |
| Parkinson's | | | | | | | | | |
| Pellagra | x | | | | | | | | |
| Pernicious | | x | | | | | | | |
| Anemia | | | | | | | | | |
| Pheochromocytoma | | | | | | | | x | |
| Pneumonia | | | | | | | | | |
| Porphyria | x | x | | | | | | | |
| Postoperative | x | x | | | | | | | |
| States | | | | | | | | | |
| Premenstrual | | | | | | | | | |
| Syndrome | | | | | | | | | |
| Prion Disease | x | | | | | | | | |
| Progressive | | | | | | | | | |
| Supranuclear | | | | | | | | | |
| Palsy | | | | | | | | | |
| Protein Energy | x | | | | | | | | |
| Malnutrition | | | | | | | | | |
| Pulmonary | | | | | | | | | |
| Thromboembolism | | | | | | | | | |
| Rheumatoid | x | | | | | | | | |
| Arthritis | | | | | | | | | |
| Sickle Cell | | | | | | | | | |
| Disease | | | | | | | | | |
| Sleep Apnea | x | | | | | | | | |
| Syphilis | x | x | | | x | | | | |
| Systemic | x | | | | | | | | |
| Infection | | | | | | | | | |
| Systemic Lupus | x | | | | | | | | |
| Erythematosus | | | | | | | | | |
| Thiamine | | | | | | x | | | |
| Deficiency | | | | | | | | | |
| Wilson's | x | | | | | | | | |

First column legend:
C, common;
F, frequent;
U, uncommon;
R, rare;
N, normal

TABLE 2
Medical Disorders That Can Cause Mental Disorders (Cognitive and Personality)

| | Cognitive Symptoms | | | | | | | | |
|---|---|---|---|---|---|---|---|---|---|
| | | | | Minor | | | | | |
| | Relative | Memory | Disorien- | Cognitive | | | Inatten- | Slow | Mental |
| | Frequency | Impairment | tation | Impairment | Delirium | Dementia | tion | Thinking | Retardation |
| Adrenal | U | x | x | | x | | | | |
| Insufficiency | | | | | | | | | |
| AIDS | F | x | x | x | x | x | x | x | |
| Altitude | U | x | x | | x | | | | |
| sickness | | | | | | | | | |
| Amyotrophic | U | | | | | x | | | |
| Lateral | | | | | | | | | |
| sclerosis | | | | | | | | | |
| Antidiuretic | F | | | | x | | | | |
| Excess | | | | | | | | | |
| Brain Abscess | U | | x | | | | x | | |
| Brain Tumor | F | x | | | | x | | x | |
| Cancer | C | | | | x | | | | |
| Carcinoid | F | | | | | | | | |
| Cardiac | C | | | | x | | | | |
| Arrhythmia | | | | | | | | | |
| Cerebrovascular | C | | | | | | x | | |
| Disease | | | | | | | | | |
| Chronic | C | x | | | x | x | x | | |
| Obstructive | | | | | | | | | |
| Lung Disease | | | | | | | | | |
| Congestive Heart | C | | | x | x | | | | |
| Failure | | | | | | | | | |
| Cryptococcosis | F | | x | | | x | | | |
| Cushing's | F | x | | | x | x | x | | |
| Deafness | C | | | | x | | | | |
| Diabetes | C | | | | | | | | |
| Mellitus | | | | | | | | | |
| Epilepsy | C | | | | | | | | x |
| Fibromyalgia | C | x | | x | | | x | x | |
| Head Trauma | C | x | x | | x | x | x | x | |
| Herpes | U | x | | | | | | | |
| Encephalitis | | | | | | | | | |
| Homocystinuria | U | | | | | x | | | x |
| Huntington's | U | x | | | | x | | | |
| Hyperparathyroidism | F | x | | | x | | x | x | |
| Hypertensive | F | x | x | | x | | | x | |
| Encephalopathy | | | | | | | | | |
| Hyperthyroidism | C | | | | x | | | | |
| Hypoparathyroidism | U | x | x | | x | x | | x | |
| Hypothyroidism | C | x | | | | x | x | x | |
| Kidney Failure | F | x | | | x | x | x | | |
| Kleinfelter's | F | | | | | | | | x |
| Liver Failure | C | | | | x | | x | | |
| Lyme Disease | F | x | | | | | | | |
| Meniere's | F | | | | | | | | |
| Menopause | N | | | | | | x | | |
| Migraine | C | | | | | | | x | |
| Mitral Valve | C | | | | | | | | |
| Prolapse | | | | | | | | | |
| Multiple | F | x | | | | x | | | |
| Sclerosis | | | | | | | | | |
| Myasthenia | F | x | | | | | | | |
| Gravis | | | | | | | | | |
| Neurocutaneous | F | | | | | x | | | x |
| Diseases | | | | | | | | | |
| Normal-pressure | F | x | | | | x | | | |
| Hydrocephalus | | | | | | | | | |
| Parkinson's | F | | | | | x | | | |
| Pellagra | R | | x | | | x | | | |
| Pernicious | C | x | | | | x | | | |
| Anemia | | | | | | | | | |
| Pheochromocytoma | U | | | | | | | | |
| Pneumonia | C | | | | x | | | | |
| Porphyria | U | | x | | | | | | |
| Postoperative | F | | x | | x | | x | | |
| States | | | | | | | | | |
| Premenstrual | C | | | | | | x | | |
| Syndrome | | | | | | | | | |
| Prion Disease | R | x | | | | x | x | x | |
| Progressive | U | | | | | x | | | |
| Supranuclear | | | | | | | | | |
| Palsy | | | | | | | | | |
| Protein Energy | C | | | x | | | | | |
| Malnutrition | | | | | | | | | |
| Pulmonary | F | | | | x | | | | |
| Thromboembolism | | | | | | | | | |
| Rheumatoid | C | | | | | | | | |
| Arthritis | | | | | | | | | |
| Sickle Cell | F | | | | | | | | x |
| Disease | | | | | | | | | |
| Sleep Apnea | C | x | x | x | | | x | | |
| Syphilis | U | x | | x | | x | | | |
| Systemic | C | | x | x | x | | | | |
| Infection | | | | | | | | | |
| Systemic Lupus | F | | | | x | x | | | |
| Erythematosus | | | | | | | | | |
| Thiamine | F | x | x | | x | | x | | |
| Deficiency | | | | | | | | | |
| Wilson's | U | | | | | x | | | |

| | Personality Symptoms | | | | | | | |
|---|---|---|---|---|---|---|---|---|
| | Irrita- | | Disin- | | Impulsive- | Tenacious- | Aggres- | |
| | bility | Apathy | hibition | Jocularity | ness | ness | sion | Criminality |
| Adrenal | x | x | | | | | | |
| Insufficiency | | | | | | | | |
| AIDS | x | x | | | | | | |
| Altitude | x | | | | | | | |
| sickness | | | | | | | | |
| Amyotrophic | | | | | | | | |
| Lateral | | | | | | | | |
| sclerosis | | | | | | | | |
| Antidiuretic | x | | | | | | | |
| Excess | | | | | | | | |
| Brain Abscess | | | | | | | | |
| Brain Tumor | | x | x | | x | | | |
| Cancer | | | | | | | | |
| Carcinoid | | | | | | | | |
| Cardiac | | | | | | | | |
| Arrhythmia | | | | | | | | |
| Cerebrovascular | | x | x | x | x | | | |
| Disease | | | | | | | | |
| Chronic | | x | | | | | | |
| Obstructive | | | | | | | | |
| Lung Disease | | | | | | | | |
| Congestive Heart | | | | | | | | |
| Failure | | | | | | | | |
| Cryptococcosis | x | | | | | | | |
| Cushing's | x | | | | | | | |
| Deafness | | | | | | | | |
| Diabetes | | | | | | | | |
| Mellitus | | | | | | | | |
| Epilepsy | | | | | | x | | |
| Fibromyalgia | | | | | | | | |
| Head Trauma | x | x | x | | x | | | |
| Herpes | | | | | | | x | |
| Encephalitis | | | | | | | | |
| Homocystinuria | | | | | | | | |
| Huntington's | x | x | x | | | | x | |
| Hyperparathyroidism | x | x | | | | | | |
| Hypertensive | | | | | | | | |
| Encephalopathy | | | | | | | | |
| Hyperthyroidism | x | | | | | | | |
| Hypoparathyroidism | x | | | | | | | |
| Hypothyroidism | x | x | | | | | | |
| Kidney Failure | | | | | | | | |
| Kleinfelter's | | | | | | | x | x |
| Liver Failure | x | | | | | | | |
| Lyme Disease | | | | | | | | |
| Meniere's | | | | | | | | |
| Menopause | x | | | | | | | |
| Migraine | x | | | | | | | |
| Mitral Valve | | | | | | | | |
| Prolapse | | | | | | | | |
| Multiple | | | | | | | | |
| Sclerosis | | | | | | | | |
| Myasthenia | | | | | | | | |
| Gravis | | | | | | | | |
| Neurocutaneous | | | | | | | | |
| Diseases | | | | | | | | |
| Normal-pressure | | | | | | | | |
| Hydrocephalus | | | | | | | | |
| Parkinson's | | | | | | | | |
| Pellagra | x | x | | | | | | |
| Pernicious | x | | | | | | | |
| Anemia | | | | | | | | |
| Pheochromocytoma | | | | | | | | |
| Pneumonia | | | | | | | | |
| Porphyria | | | | | | | | |
| Postoperative | | | | | | | | |
| States | | | | | | | | |
| Premenstrual | x | | | | | | | |
| Syndrome | | | | | | | | |
| Prion Disease | | | | | | | | |
| Progressive | | | | | | | | |
| Supranuclear | | | | | | | | |
| Palsy | | | | | | | | |
| Protein Energy | | x | | | | | | |
| Malnutrition | | | | | | | | |
| Pulmonary | | | | | | | | |
| Thromboembolism | | | | | | | | |
| Rheumatoid | | | | | | | | |
| Arthritis | | | | | | | | |
| Sickle Cell | | | | | | | | |
| Disease | | | | | | | | |
| Sleep Apnea | x | | | | | | | |
| Syphilis | x | | | | | | | |
| Systemic | | | | | | | | |
| Infection | | | | | | | | |
| Systemic Lupus | | | | | | | | |
| Erythematosus | | | | | | | | |
| Thiamine | | x | | | | | | |
| Deficiency | | | | | | | | |
| Wilson's | x | | | | | | | |

Tables 1 and 2, provided herein for illustration and not meant to be exhaustive, illustrate the cross-correlation between physical health and mental health. Returning back to FIG. 6, in block 614, a cross-correlation engine analyzes the data with the physical assessment results (602, 604, and 606) and emotional health assessments results (608, 610, and 612) as inputs using the data similar to that presented in Tables 1 and 2 to produce an individual wellness prescription 620 for each participant that explains exactly what they need to do in order to get healthy. In the absence of the cross-correlation, an accurate assessment of how to prescribe what it would take to proactively provide wellness will be virtually impossible to assess. The importance of cross-correlation is further validated with the fact that in order to improve participant physical health to a level that minimizes the possibility of contracting non-communicable diseases, the number one killer of humans worldwide, it is absolutely essential that mental health issues be known and adequate relief from those issues be effected, as recent studies have proven. Further, participants invariably have no idea about the complexities of physical and mental interactions as presented in Tables 1 and 2 due to the subtleties and often asymptomatic nature of the thousands of possible internal mind/body interactions that must be exposed by adequate testing by professionals. Thus, in order to achieve the wellness prescription's ultimate directives for optimum health, cross-correlations must be understood and factored into the wellness prescription in such a fashion that they are uniquely and coherently understood.

The cross-correlation engine 614 incorporates artificial intelligence to generate the wellness prescription. For instance, assuming a patient diagnosed with medical condition of Adrenal Insufficiency, using Table 1, a determination is made that the patient may be suffering from one or more of the following: Depression, Anxiety, Withdrawal, Hallucinations, Delusions, and Suicidal Ideation. With information about the mental and physical health of the patient, a wellness prescription is generated.

The wellness prescription system 600 may further comprise a separate module 616 for assessing return on investment. Module 616 is configured to predict the dollar savings in both healthcare expenses and employee productivity that occur when an employee drops from the “high risk” status on any of the major health risk factors.

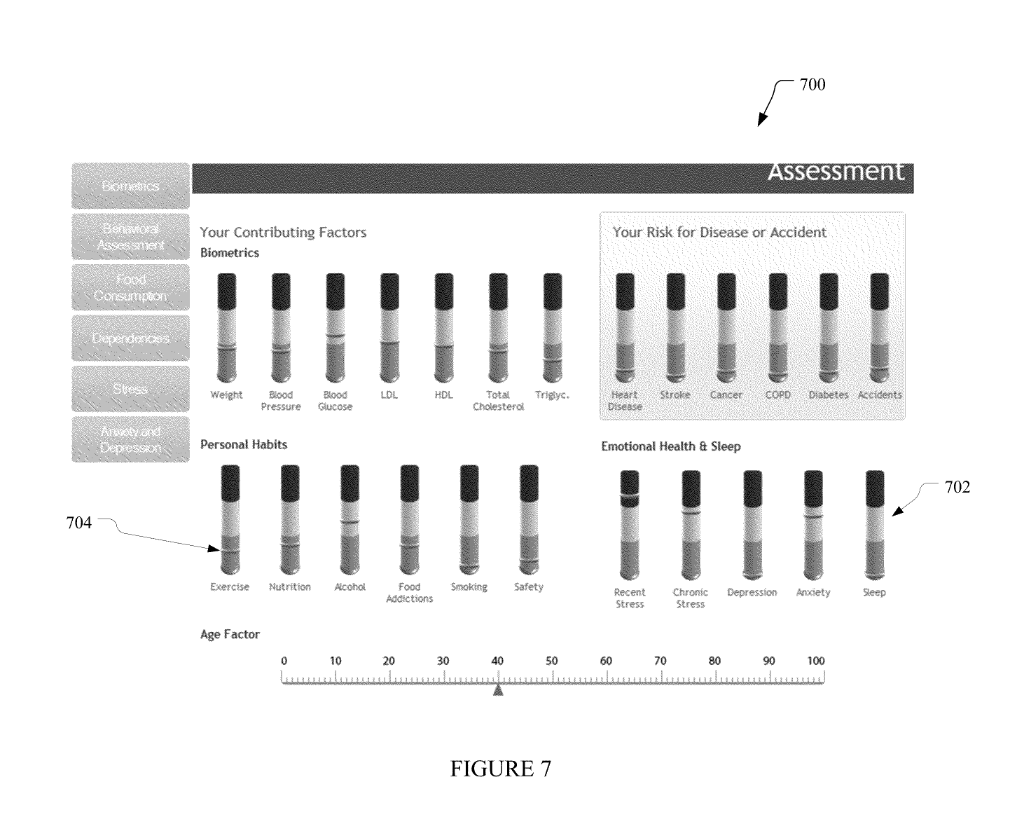

FIG. 7 is an illustration of the graphical wellness assessment 700 provided to each individual in accordance with one or more embodiments of systems and methods for wellness program administration and evaluation. In this illustration, each cylinder, e.g. 702, and movable silver slider, e.g. 704, wrapped around it, tells the participant the degree of risk they possess for each measure. This fully interactive model allows users to physically move each slider to perform “what if” scenarios and to see what impact losing weight or reducing their cholesterol, for example, would have on their risk for chronic disease development. As new data is entered the system can literally “playback” the participants history as they click on different time periods and watch the sliders reposition. This anytime confidential access to individual health status is an important incentive.

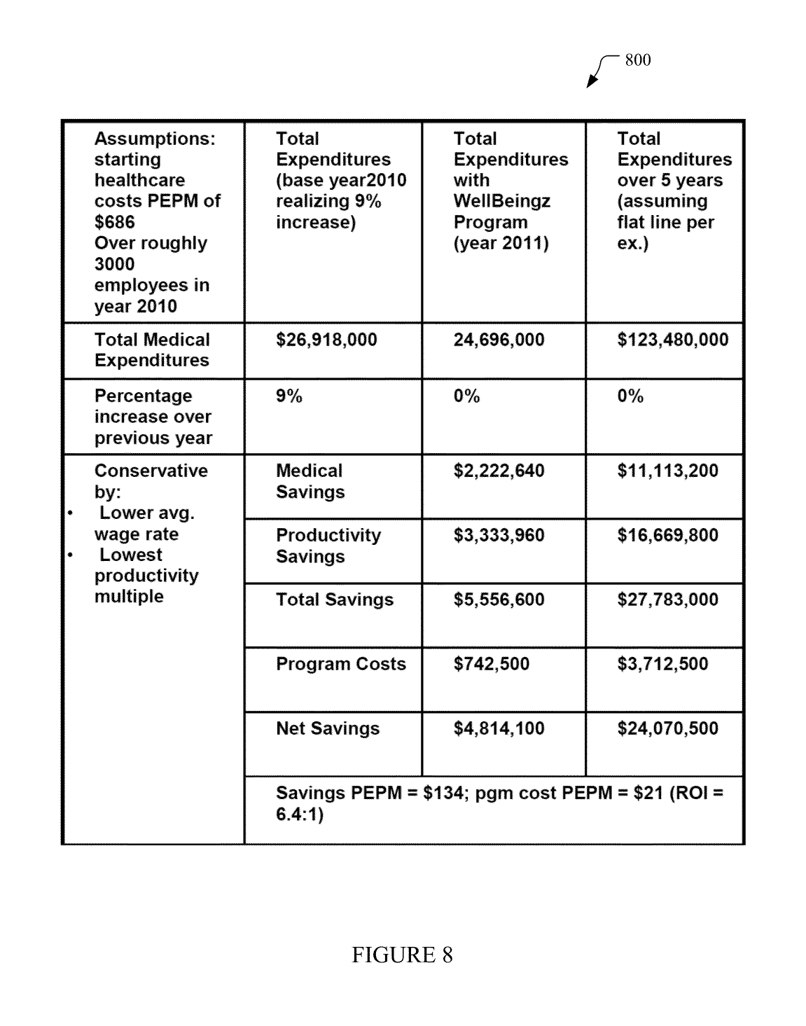

FIG. 8 is an exemplary ROI analysis 800 in accordance with one or more embodiments of systems and methods for wellness program administration and evaluation. This table illustrates actual numbers from a corporate program where wellness providers were positioned within the organization to execute the wellness program. As is illustrated in 800, the company was able to project a zero increase in healthcare expenditures, over a five-year period, backed by study data and tables on healthcare costs relative to expenses associated with certain health conditions. The final return on investment for the corporate client was computed at over 6 to 1 for the five years depicted despite choosing the lowest average wage rate for the employee population and the lowest productivity multiple.

Although the systems and methods for wellness program administration and evaluation have been described with reference to embodiments and examples, it should be understood that numerous and various modifications can be made without departing from the spirit of the invention. Accordingly, the invention is limited only by the following claims.

What is claimed is:

1. A method for administering a wellness program comprising:
receiving data corresponding to physical and psychological characteristics of at least one patient, wherein said psychological characteristics comprises oral examination of said at least one patient by a Clinical Therapist;
determining one or more risk factors corresponding to one or more conditions based, at least in part, on a cross-correlation analysis of said physical and psychological characteristics of said at least one patient and assembling comprehensive mind-body risk factor reduction data based on said one or more risk factors;
determining one or more wellness prescriptions based, at least in part, on said comprehensive mind-body risk factor reduction data;
administering said one or more wellness prescriptions to said at least one patient; and
updating risk factor profile of said at least one patient based on response to said wellness prescriptions.
